(19) United States
(12) Patent Application Publication
(10) Pub. No.: US 2009/0177638 A1
(43) Pub. Date: Jul. 9, 2009

(54) REPORT GENERATION IN AN INTELLECTUAL PROPERTY DATABASE

(75) Inventor: Andrew William Bergstrom, Minneapolis, MN (US)

Correspondence Address: COMPUTER PATENT ANNUITIES NORTH AMERICA, LLC;C/O CPA GLOBAL, P.O. BOX 52050, MINNEAPOLIS, MN, 55402, US

(73) Assignee: FOUNDATIONIP, LLC, Minneapolis, MN (US)

(21) Appl. No.: 12/331,366

(22) Filed: Dec. 9, 2008

Related U.S. Application Data
(60) Provisional application No. 60/996,861, filed on Dec. 10, 2007.

(51) Int. Cl. G06F 17/30

(52) U.S. Cl. 707/4; 707/E17.014; 707/E17.054

(57) ABSTRACT

A method, system, and article are provided for extending the functionality of a report generated in response to submission of a query to a database supporting management of patent related documents. Due dates for documents submission are tracked by the management tool. A graphical user interface is provided as an overlay to the query submission to facilitate entry of the filters for fields to be joined in the query, and to support placement of a further constraint on the joined fields. In response to the query, a report is generated. Organization of the report limits association of one constraint data item per filtered data item per row in the report.

### BACKGROUND OF THE INVENTION

1. Technical Field

This invention relates to report generation from data retained and organized in a relational database. More specifically, the invention relates to an interface to organize and leverage blocks of data in the database to create and return a user friendly report.

2. Description of the Related Art

Patent agents and attorneys that specialize in patent prosecution typically prepare and prosecute multiple patent applications. Each of these pending patent applications must be carefully tracked by the patent attorney or their legal assistant, so that important status information such as potential bar dates, deadlines for response to office action amendments and responses, and other data are not overlooked. Management of this data has historically been managed by inclusion of each item on a docket that is tracked on paper docketing calendars, or more recently using commercially available electronic docketing software that serves the same purpose as a calendar.

Management of this data becomes complex when multiple attorneys are involved in docketed matters for multiple clients, when complex client or legal rules must be applied, and/or when corporate clients wish to participate in the docket management of matters on a law firm or attorney's docket. Docket management using paper calendars and simple docketing software can become labor-intensive and subject to errors. It is not uncommon for paper checklists of application drafting guidelines from clients, electronic mail messages relating to a case, and multiple copies of docketing information to be kept separately for each patent or trademark application managed by an attorney or firm. Coordination and communication of this information is not a trivial task, and requires a significant amount of time and attention from the typical patent attorney or agent.

It is recognized in the field, that there are various tools that are employed by patent professionals to facilitate management of patent applications. Such tools organize data for the subject application(s) in some form of a database. To facilitate communication and coordination of subject application-related information, it is desired to render periodic reports for the underlying data. However, the organization of the reports is critical to the conveyance of the underlying information. Accordingly, there is a need in the art for rendering reports of the underlying data in a manner that supports selection and organization of data and presentation of the selected and organized data in a user-friendly manner.

### SUMMARY OF THE INVENTION

This invention comprises an article and system for automating submission of patent documents to a government agency.

In one aspect of the invention, a computer implemented method is provided for generating reports from an electronic database. Data is organized in a relational database, and a graphical user interface is employed as an abstract layer over the database. The graphical user interface includes a first field to receive a first block of data in the database, and a second field to receive a second block of data in the database. A filter is applied to each of the first and second fields in the graphical user interface, with the first field representing the first block of data in the database and the second field representing the second block of data in the database. A constraint is placed on one of the first and second blocks of data in the database, as represented in the fields of the graphical user interface. The constraint parses the data in one of the first and second fields. A first query is executed in the database. The query converts the first and second blocks of data received in the first and second fields and the constraint placed on one of the first and second fields, into a query for the relational database. A report is generated as a result of the query execution. The report organizes the data returned from the query with a limit of one filter and one constraint per row.

In another aspect of the invention, a computer system is provided with a server having a processor and memory. The server is in communication with a storage media and a database maintained on the storage media. A client machine is provided with a processor and memory. The client machine is in communication with the server across a network connection, and employs an application manager to facilitate communication of a query to the server. A query manager is provided local to the server and in communication with the application manager. The query manager employs a graphical user interface as an abstract layer over the database. The graphical user interface includes a first field to receive a first block of data in the database, a second field to receive a second block of data in the database, and a filter applied to the first and second fields. The first field represents the first block of data in the database and the second field represents the second block of data in the database. The graphical user interface also includes a field to receive a constraint placed on one of the first and second blocks of data in the database, wherein the constraint further parses the data in one of the first and second fields. A manager is provided in communication with the graphical user interface to execute a first query in the database. The query converts the first and second blocks of data received in the first and second fields and the constraint placed on one of the first and second fields into a query for the relational database. A report is generated from the query execution. This report organizes the query result data with a limit of one filter and one constraint per row.

In a further aspect of the invention, an article is provided configured to generate and format a report from a database embodied in a computer readable carrier, including computer program instructions configured to build the report. Instructions are provided to apply a filter to first and second fields in a graphical user interface. The first field represents a first block of data in the database, and the second field represents a second block of data in the database. Instructions are further provided to place a constraint on one of the first and second blocks of data in the database. The constraint further parses the data in one of the first and second fields. Instructions are provided to execute a first query in the database, including application of the constraint to a join of the first and second fields. Finally, instructions are provided to organized data generated from the execution of the query into a primary report with a limit of one filter and one constraint per row.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a flow chart of a prior art process for generation of a report from data organized in a relational database.

FIG. 2 is a block diagram of a prior art report generated from the relational database.

FIG. 3 is a flow chart illustrating generation of a report from data organized in a relational database according to a preferred embodiment of this invention, and is suggested for printing on the front page of the published patent application.

FIG. 4 is a block diagram of a report generated from the relational database, based upon the process illustrated in FIG. 3.

FIG. 5 is a block diagram illustrating placement of the components of the hardware tools in a computer system to support the report generation illustrated in FIG. 3.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as managers. A manager may be implemented in programmable hardware devices such as field programmable gate arrays, programmable array logic, programmable logic devices, or the like. The manager may also be implemented in software for execution by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a request manager, an integration manager, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference is also made throughout of a report created from the underlying data present in the database. In this disclosure, an individual report is an electronic document which represents a particular physical and/or tangible document (e.g. before and/or after the physical/tangible document is converted to and/or from electronic form).

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

A report generation tool is provided to enable users of a patent management tool to generate a report from data retained within the patent management tool. More specifically, the report generation tool is in communication with patent management tool and it's associated database for organizing and storing documents pertaining to one or more pending or granted intellectual property assets. The report generation tool places filters and constraints on select data blocks to extracts all relevant data from the database. The filters and constraints are leverage to generate a report in a manner that organizes the data in a user friendly manner. More specifically, the report parses the data so that each data associated with the filter is limited to a single constraint. Accordingly, the functionality of the patent management tool is extended to support employment of both filters and constraints for blocks of data for report generation, and to integrate both the filters and constraints to create an organized report of the underlying patent assets.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

The report creation tool, hereinafter referred to as the report tool, is employed to leverage the data retained in the underlying database. More specifically, a filter and/or a constraint are placed on one or more blocks of data. In a database, a block is the smallest amount of data that a program can request. It is a multiple of an operating system block, which is the smallest amount of data that can be retrieved from storage or memory. In this disclosure, an individual report is an electronic document which represents a particular physical/tangible document, including both before and/or after the physical/tangible document is converted to an/or from electronic form.

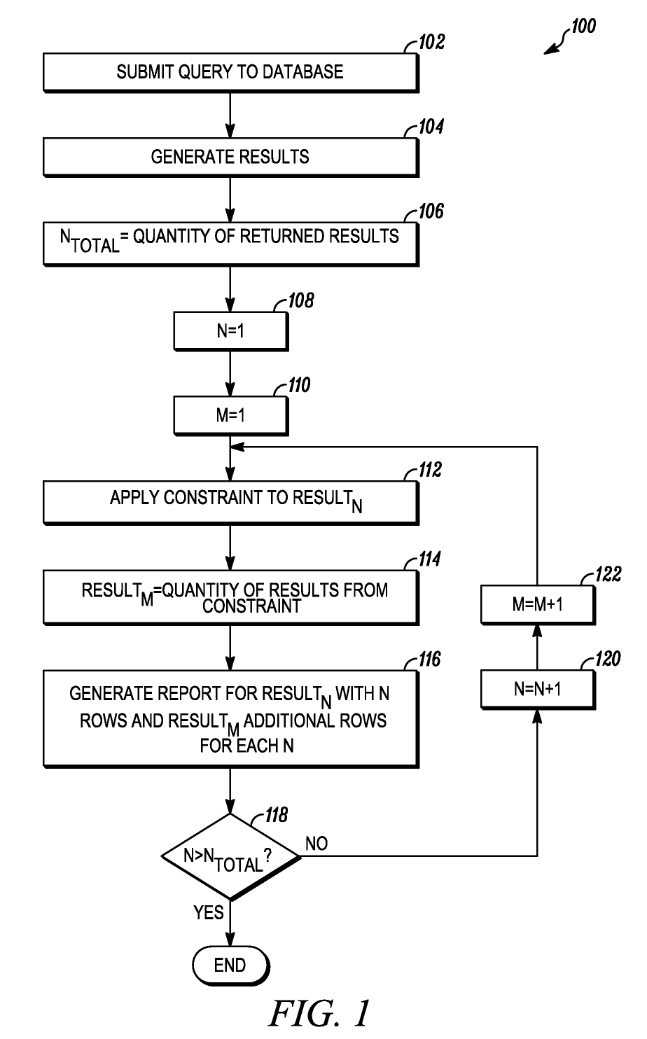

FIG. 1 is a block diagram (100) illustrating a prior art process for generating a report from data retained in an underlying database. More specifically, a query is submitted to the database (102) and results are generated (104). The variable N_{Total} is assigned to the quantity of returned results (106), and a counting variable N is assigned to the integer one (108) and a counting variable M is assigned to the integer one (110). Thereafter, a constraint is applied to the result generated from the submitted query, Result_{N}, (112). The variable Result_{M} is assigned to the quantity of results returned from the application of the constraint (114). The data associated with both Result_{N} and Result_{M} are compiled into the format of a report to be generated (116). More specifically, the report generated has a first column representing the filter data and a second representing the constraint data. One row is provided for each filter data item, with a range of zero to multiple constraint data items, Result_{M} number, in the second column. In one embodiment, each row for Result_{N} may be attached with multiple rows of in the column representing the associated constraint. Following step (116), it is determined if there are anymore results from the query to which constraints have to be applied (118). A negative response to the determination at step (118) is followed by an increment of the variable N (120) and an increment of the variable M (122), and a return to step (110). Conversely, a positive response to the determination at step (118) concludes the processing of data to generate a report.

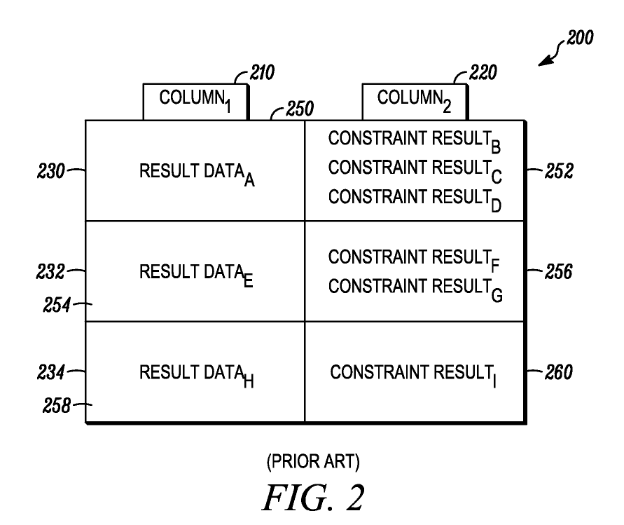

As shown in FIG. 1, a constraint may be placed on the data returned from a query. FIG. 2 is a prior art block diagram (200) illustrating organization of the processed data from FIG. 1. As shown, there are two columns of data, a first column (210) and a second column (220), and three rows of data (230), (232), and (234). The first column (210) represents result data returned from submission of the query to the database. Similarly, the second column (220) represents constraint data returned from placing a constraint on the result data. In the example shown here, the first column of the first row (250) has one result data item, and the second column of the first row (252) has three associated constraint data items. Similarly, the first column of the second row (254) has one result data item with the corresponding second column of the second row (256) having two associated constraint data items, and the first column of the third row (258) has one result data item with the corresponding second column of the third row (260) having one associated constraint data items. Accordingly, as shown, the prior art report does not organize the result data in a manner that further parses the constraints data items returned from the application of a constraint to each generated query result.

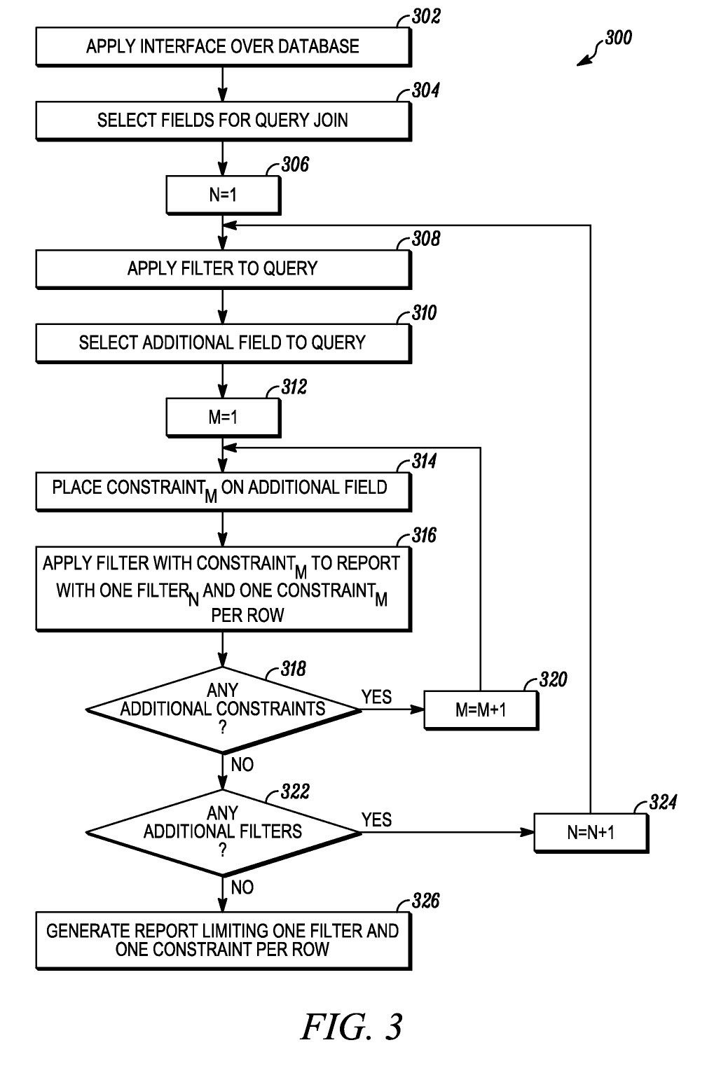

FIG. 3 is a flow chart (300) illustrating a process for submitting a query to a database and generating a report based upon the query. An interface is applied as an abstract layer over a database (302). In one embodiment, the interface is a graphical user interface to facilitate input of data for a query to the database. Fields are selected for joining in a query (304), with each field representing one or more blocks of data in the underlying database. A counting variable N is assigned the integer 1 (306), followed by applying a filter_{N} to the query (308). In one embodiment, the filter is an abstraction in the graphical user interface. Following step (308), an additional field is selected for the query (310), a variable M is assigned to the integer one (312), and at least one constraint_{M} is placed on the additional field (314). Both filter_{N} and constraint_{M} are populated into a non-final report, with one filter and one constraint assigned to each row (316). Following step (316), it is determined if any additional constraints are to be applied to filter_{N} (318). A positive response to the determination at step (318) is followed by an increment of the variable M (320), and a return to step (314). Conversely, a negative response to the determination at step (318) is followed by a determining if there are any additional filters to be applied to the report (322). A positive response to the determination is followed by an increment of the variable N (324), followed by a return to step (308). Conversely, a negative response to the determination at step (324) is followed by a compilation and generation of the final report with a limit of one filter and one constraint per row in the report (326). As demonstrated herein each filter may have one or more constraints applied thereto. However, regardless of the quantity of filters and constraints, the organization of the report data is compiled in a strict format that limits the presentation of the quantity of constraints assigned to each filter. In one embodiment, each filter with an associated constraint may return multiple data items, with each data item associated with the filter presented in a different row of the report. At the same time, the column of the report representing the filter data will repeat the filter data item in the row for each multiple constraint data item. Accordingly, regardless of the quantity of constraints and filters, the report structure will limit the quantity of constraint data items placed in a row of the report to a single returned data item.

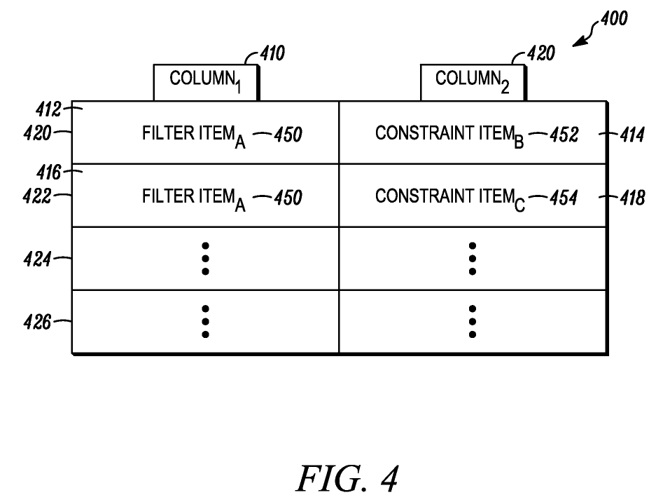

To facilitate visualizing the organization of the report, a generic structure of the report is shown in FIG. 4. More specifically, FIG. 4 is a block diagram (400) illustrating the organization of filter data in conjunction with returned constraint data items based upon the structure described above in FIG. 3. As shown, there are two columns of data, a first column (410) and a second column (430), and four rows of data, including a first two (420), a second row (422), a third row (424), and a fourth row (426). Each row and column represented in the report is limited to a single data item. More specifically, a first cell (412) representing the first row (420) and the first column (410) has a first filter data item (450), with a first corresponding constraint data item (452) shown in the second cell (414), representing the first row (420) second column (430). A third cell (416) representing the second row (422) and the first column (410) has the first filter data item (450), with a second corresponding constraint data item (454) in a fourth cell (418). This process continues for each of the filters and constraints employed in the query. Accordingly, the organization of the data items applies the filter data item in subsequent rows, for each multiple constraint data generated from the application of the query.

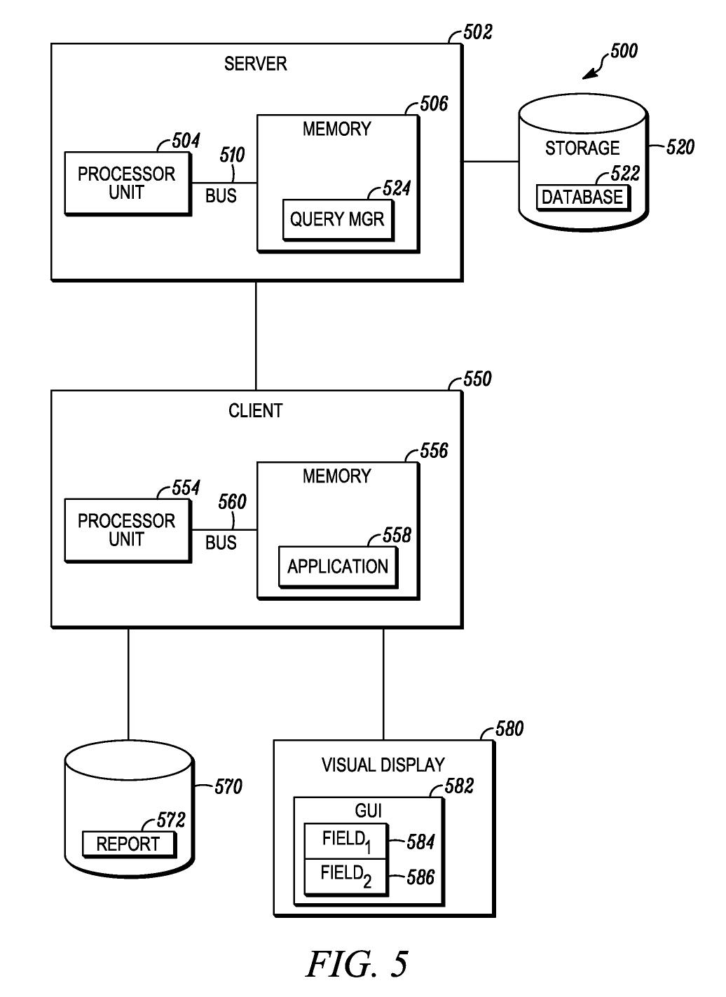

There are several underlying requirements to support the creation of the report in the manner disclosed herein. FIG. 5 is a block diagram (500) illustrating placement of the managers as hardware tools in a computer system. The illustration shows a server (502) with a processor unit (504) coupled to memory (506) by a bus structure (510). Although only one processor unit (504) is shown, in one embodiment, the computer system (502) may include more processor units in an expanded design. The computer system includes data storage (520) in communication with the server (502). The data storage unit is employed for retention of a database (522) and a collection of documents associated therewith. In one embodiment, the database is a patent management system and the documents are a collection of documents pertaining to the underlying patents and patent applications that are a part of the management system.

A query manager (524) is provided local to the memory (506) and in communication with the system (502). However, in one embodiment, the query manager may be on a remote system (not shown) that is in communication with the system (502) across a network. The query manager (524) monitors submission of queries to the database (522) retained on the data storage (520) in communication with the server (502).

A client machine (550) is provided in communication with the server (502). As with the server, the client machine is provided with a processor unit (554) coupled to memory (556) by a bus structure (560). Although only one processor unit (554) is shown, in one embodiment, the client machine (550) may include more processor units in an expanded design. An application (558) local to the client machine (550) is provided to interface with the query manager (524). The client machine (550) is provided with data storage (570) for storage of data, such as results of queries received from the server (502), and a visual display (580), for presentation of data. In one embodiment, the visual display is provided with a graphical user interface (582) to facilitate submission of queries to the database (522). As described above, the graphical user interface (582) includes fields for receiving and organizing data for query submission. More specifically, the graphical user interface (582) functions as an overlay to the underlying database. In one embodiment, the graphical user interface includes at least one field (584) to filter blocks of data, and at least a second field (586) to place a constraint on the filtered blocks of data. Following a successful submission of a query to the server (502), a report (572) is generated and retained local to the storage device (570). The report (572) is an electronic document which represents a physical/tangible document organizing data received in response to the query submission. In one embodiment, the report is returned to the data storage (570) of the client machine (550). Similarly, in one embodiment, the report is returned to the visual display (580) for presentation and use. The generated report is demonstrative of the valid submission of the query to the patent management application.

As shown herein, the query manager (524) resides in memory (506) local to the server (502), and the application manager (558) resides in memory (556) local to the client machine (550). In one embodiment, the managers (524) and (558) may reside as a hardware tool external to local memory (506), or may be implemented as a combination of hardware and software. Similarly, in one embodiment, the managers may each be separated into a plurality of components that may be collectively or individually distributed across a network and function as a unit to support query submission and report generation of a patent management tool. Accordingly, the managers (524) and (558) may be implemented as software tools, hardware tools, or a combination of software and hardware tools.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

One or more manager and/or tools are provided to support automated submission of patent related documents to a patent submission application. Due dates are monitored to ensure submission of the necessary documents to avoid payment of late fees, meeting deadlines, and/or abandonment of a pending application. Intervention by a patent practitioner is mitigated, and limited to documents that fail the submission process. Efficiency in patent prosecution is achieved and overhead is mitigated by removing the task of document submission from a patent practitioner to hardware and/or software tools.

It will be appreciated that, although specific embodiments of the invention have been described herein for purposes of illustration, various modifications may be made without departing from the spirit and scope of the invention. In particular, a unique name may be assigned to one of the blocks of data employed in the executed query. Accordingly, the scope of protection of this invention is limited only by the following claims and their equivalents.

We claim:

1. A computer implemented method for generating reports from an electronic database, comprising:
organizing data in a relational database;
employing a graphical user interface as an abstract layer over the database, comprising:
a first field for receiving a first block of data in the database, and a second field for receiving a second block of data in the database;
applying a filter to the first and second fields in the graphical user interface, with the first field representing the first block of data in the database and the second field representing the second block of data in the database;
placing a constraint on one of the first and second blocks of data in the database, as represented in the fields of the graphical user interface, wherein the constraint further parses the data in one of the first and second fields;
executing a first query in the database, including converting the first and second blocks of data received in the first and second fields and the constraint placed on one of the first and second fields, into a query for the relational database,
a primary report generated from the query execution, including an organization of the report with a limit of one filter and one constraint per row.

2. The method of claim 1, selecting a third field in the graphical user interface for receiving a third block of data in the database, and placing a constraint on the third field.

3. The method of claim 2, further comprising executing a second query in the database independent from the first query, including applying the constraint of the third field to limitation of the filter and constraints of the first query.

4. The method of claim 3, further comprising a secondary report generated from the second query, including organization of the secondary report with a limit of one filter and one constraint per row.

5. The method of claim 4, wherein the secondary report is separate from the first report.

6. The method of claim 1, further comprising assigning a unique name to one of the blocks of data employed in the executed query.

7. The method of claim 1, wherein the report is an electronic document representing a particular physical and tangible document.

8. A computer system comprising:
a server with a processor and memory, the server in communication with a storage media and a database maintained on the storage media;
a client machine, with a processor and memory, the client machine in communication with the server across a network connection;
a query manager local to the server in communication with an application manager local to the client machine, the query manager to employ a graphical user interface as an abstract layer over the database, the graphical user interface comprising:
a first field to receive a first block of data in the database, and a second field to receive a second block of data in the database;
a filter applied to the first and second fields in the graphical user interface, with the first field representing the first block of data in the database and the second field representing the second block of data in the database;
a constraint placed on one of the first and second blocks of data in the database, as represented in the fields of the graphical user interface, wherein the constraint further parses the data in one of the first and second fields;
the query manager to execute a first query in the database, including conversion of the first and second blocks of data received in the first and second fields and the constraint placed on one of the first and second fields, into a query for the relational database,
a primary report generated from the query execution, including an organization of the report with a limit of one filter and one constraint per row.

9. The system of claim 8, further comprising a visual display in communication with the client machine, the visual display being a medium to present the graphical user interface.

10. The system of claim 8, further comprising a third field in the graphical user interface selected to receive a third block of data in the database, and a constraint placed on the third field.

11. The system claim 10, further comprising the query manager to execute a second query in the database independent from the first query, including application of the constraint of the third field to limitations of the filter and constraint of the first query.

12. The system of claim 11, further comprising a secondary report generated from the second query, including organization of the secondary report with a limit of one filter and one constraint per row.

13. The system of claim 12, wherein the second report is separate from the first report.

14. The system of claim 8, further comprising a unique name assigned to one of the blocks of data employed in the executed query.

15. The system of claim 8, wherein the report is an electronic document representing a particular physical and tangible document.

16. An article configured to generate and format a report from a database, the article comprising:
a computer readable carrier including computer program instructions configured to build the report, the instructions comprising:
applying a filter to first and second fields in a graphical user interface, with the first field representing a first block of data in the database and the second field representing a second block of data in the database;
placing a constraint on one of the first and second blocks of data in the database, wherein the constraint further parses the data in one of the first and second fields;
executing a first query in the database, including applying the constraint to a join of the first and second fields,
data generated from the execution of the query and organized into a primary report with a limit of one filter and one constraint per row.

17. The article of claim 16, wherein the report is an electronic document representing a particular physical and tangible document.
